(19) United States
(12) Patent Application Publication
(10) Pub. No.: US 2021/0048214 A1
(43) Pub. Date: Feb. 18, 2021

(54) HVAC SYSTEM, HVAC METHOD AND COMPUTER PROGRAM OF HVAC SYSTEM WITH RELATIVE CONTROL

(71) Applicant: BELIMO HOLDING SA, Hinwil (CH)

(72) Inventors: Michael HEDIGER, Jona (CH); Alexander EGLI, Adetswil (CH)

(73) Assignee: BELIMO HOLDING SA, Hinwil (CH)

(21) Appl. No.: 16/975,888

(22) PCT Filed: Mar. 12, 2019
(86) PCT No.: PCT/IB2019/051996

§ 371 Date: Aug. 26, 2020

(30) Foreign Application Priority Data
Mar. 13, 2018 (CH) 00318/18

(51) Int. Cl. F24F 11/63; F24F 11/30; F24F 11/50; F24F 110/10; F24F 110/72; F24F 110/64; F24F 110/20; F24F 120/20; F24F 110/70; F24F 110/66

(52) U.S. Cl. CPC F24F 11/63; F24F 11/30; F24F 11/50; F24F 2110/10; F24F 2110/66; F24F 2110/64; F24F 2110/20; F24F 2120/20; F24F 2110/70; F24F 2110/72

(57) ABSTRACT

HVAC System for a unit with a first zone (A) and a second zone (B, C, D) comprising:
a first actuator (1) configured to change a physical variable in the first zone (A);
a second actuator (2) configured to change the physical variable in the second zone (B, C, D);
a sensor (3) configured to measure a value of the physical variable in the first zone (A);
a user input apparatus (4) for receiving user input for the second zone (B, C, D);
a control apparatus (5) configured to control the first actuator (1) on the basis of the value measured by the sensor (3) and configured to control the second actuator (2) on the basis of the configuration of the first zone (A) and on the basis of the user input for the second zone (B, C, D).

### FIELD OF THE INVENTION

The present invention concerns an HVAC system, an HVAC method and a computer program for an HVAC system for controlling a physical variable in at least two HVAC zones of a unit.

### DESCRIPTION OF RELATED ART

Traditional HVAC systems in buildings comprise at least one actuator in each zone for controlling the temperature or another physical parameter in the zones. The temperature for each zone can be controlled by regulating manually the actuator for each zone.

More sophisticated HVAC systems comprise a feedback control structure comprising in each zone at least one temperature sensor for measuring the temperature in this zone. The at least one actuator of each zone is automatically controlled on the basis of the measurement of the actual temperature in this zone and a target temperature (often received by a user input). This control system provides a very precise control of the temperature in each zone. However, it has the disadvantage that each zone requires the installation of a sensor. This requires significant time and a large number of devices to be installed and connected for commissioning buildings with new HVAC systems or re-commissioning buildings with existing traditional control structures.

### BRIEF SUMMARY OF THE INVENTION

It is an object to provide a simple and efficient control for HVAC systems.

According to the invention, this object is solved by an HVAC system, an HVAC method and a computer program according to the independent claims.

The use of a sensor that measures the physical variable in one zone for controlling the actuators in several adjacent zones allows an automatic control of several zones without the need to install a sensor in all zones.

The dependent claims refer to further embodiments of the invention.

### BRIEF DESCRIPTION OF THE DRAWINGS

The invention will be better understood with the aid of the description of an embodiment given by way of example and illustrated by the figures, in which:

FIG. 1 shows an exemplary HVAC system according to the invention.

FIG. 2 shows a first exemplary user interface for a user input apparatus.

FIG. 3 shows a second exemplary user interface for a user input apparatus.

FIG. 4 shows an exemplary HVAC method according to the invention.

FIG. 5 shows a third exemplary user interface for a user input apparatus.

FIG. 6 shows a fourth exemplary user interface for a user input apparatus.

FIG. 7 shows a fifth exemplary user interface for a user input apparatus.

### DETAILED DESCRIPTION OF POSSIBLE EMBODIMENTS OF THE INVENTION

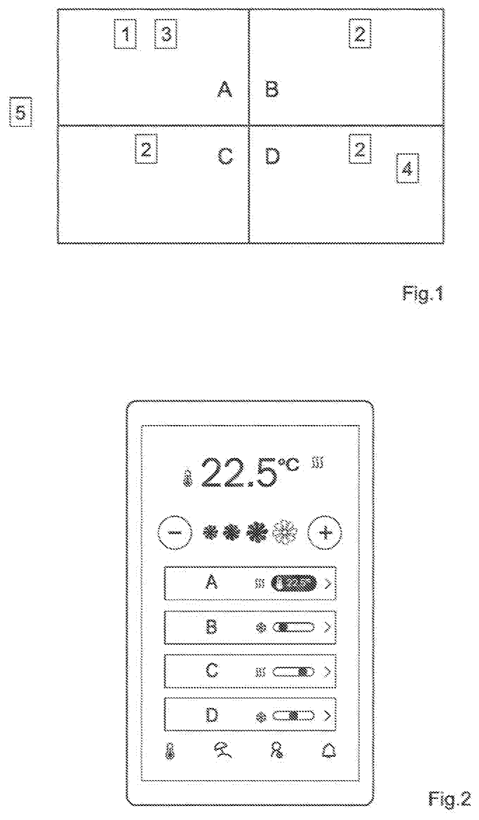

FIG. 1 shows an exemplary embodiment of a heating ventilation air conditioning (HVAC) system. The HVAC System is installed in a unit with at least two zones, in FIG. 1 four zones A, B, C, D. The unit can be a building, a house, an apartment, a floor, an area. The unit can also comprise different sub-units, wherein each sub-unit comprises at least two zones. Sub-units could be for example areas, floors or apartments of a building or house. A zone A, B, C, D corresponds preferably to a separate room of the mentioned unit or sub-unit. Each unit and/or each sub-unit comprise a first zone A and at least one second zone B, C, D associated with the first zone A as explained in more detail below. Preferably, the first zone A and at least one of the second zones B, C, D are in different rooms. However, a zone A, B, C, D can also comprise more than one room or a room can comprise more than one zone A, B, C, D.

The HVAC system for the unit comprises a first actuator 1, at least a second actuator 2, a sensor 3, a user input apparatus 4 and a control apparatus 5.

The HVAC system is configured to control a physical parameter in the unit, in particular in the first zone A and in the at least one second zone B, C, D. The physical parameter is preferably the temperature. However, the physical parameter can also be a concentration of carbon dioxide (CO2), carbon monoxide (CO), aerosols, volatile organic compounds (VOC) or hydrogen ions (H+), a concentration of particles, the humidity or other. The physical parameter can be multi-dimensional and comprises at least two of (or any combination of) the temperature, the concentration of particles, the humidity, the concentration of carbon dioxide.

The HVAC system can provide heating, cooling, ventilation, air conditioning or any combination of those functions. Preferably, the HVAC system comprises an HVAC fluid which is delivered to each of the zones A, B, C, D to control the physical parameter in those zones A, B, C, D. The HVAC fluid can be liquid, for example water. The HVAC fluid can be a gas like air or steam. Obviously HVAC fluids and HVAC gases comprise also dispersion. For example the HVAC gas can be an aerosol (gas containing solid and/or liquid particles) like often the case for air. For example the HVAC liquid can be a solution (liquid containing gas and/or a not dissolved other liquid and/or solid small particles) or a suspension. The HVAC fluid can be conducted through radiators, hot water coils or other heat exchangers at or in the walls, in the ceiling, in the floor in each zone A, B, C, D or in an air conduct for the respective zone A, B, C, D to heat or to cool or to influence the conditions in the respective zone A, B, C, D. The HVAC fluid can also be air which is conducted to each zone A, B, C, D. Preferably, the HVAC system comprises a conduct system for conducting the HVAC fluid to each zone A, B, C, D. The HVAC system can comprise more than one HVAC fluid, e.g. air for air conditioning and ventilation and water for heating. In a preferred embodiment, the physical parameter in one/each of the zones A, B, C, D can be controlled by the actuator 1, 2 of this zone A, B, C, D by influencing the HVAC fluid or fluids for this zone A, B, C, D. The actuators 1, 2 could influence the mass flow rate (e.g. damper for air conduct or valve for water) of the HVAC fluid for the respective zone A, B, C, D. An example for such an actuator 1, 2 is a damper actuator controlling the air flow rate from a (supply and/or return) air conduct system into one of the zones A, B, C, D in order to control the temperature, the concentration of CO2, the concentration of particles, the humidity or others in this zone A, B, C, D. Another example for such an actuator 1, 2 is a valve actuator controlling the water flow rate from a (hot or cold) (supply and/or return) water conduct system into one of the zones A, B, C, D in order to control the temperature in this zone A, B, C, D. The actuator 1, 2 could influence directly the physical parameter in the HVAC fluid. An example would be heating coils in the (supply) air or water conducts. Another example for an actuator 1, 2 is a humidifier or dehumidifier in the (supply) air conduct for a zone A, B, C, D to change the humidity of this zone A, B, C, D. Another example for an actuator 1, 2 is a mixer for mixing exhaust air from a zone A, B, C, D to the supply air of this zone A, B, C, D. In a further embodiment, it is also possible to vary the physical parameter de-centrally without an HVAC fluid. This can be realized for example by electrical heaters as actuators 1, 2 in each zone. The actuator 1, 2 for a zone A, B, C, D can vary the physical variable in this zone A, B, C, D independent from other devices or together with another actuator/device. In one embodiment, the other actuator/device influences the physical parameter of (only) this zone A, B, C, D (like the actuator 1, 2). In another embodiment, the other actuator/device influences the physical parameter of at least two of the zones A, B, C, D.

The first actuator 1 is configured to change/control the physical variable in the first zone A. In one embodiment, the first actuator 1 is configured to receive a first control signal from the control apparatus 5 controlling the actuator position or actuator mode. In one embodiment, the first actuator 1 is not able to control/influence the physical variable in one of the second zones B, C, D and/or any other zone than the first zone A. In one embodiment, the first actuator 1 is arranged in the (supply and/or return) HVAC fluid conduct (including at its outlet), preferably in a branch of the HVAC fluid conduct which supplies only the zone A and/or which does not supply (one of) the second zone B, C, D. In another embodiment, the first actuator 1 is arranged in the extract or exhaust HVAC fluid conduct (including at its inlet), preferably in a branch of the exhaust HVAC fluid conduct which receives the extract or exhaust HVAC fluid only from the first zone A and/or which does not receive the extract or exhaust HVAC fluid from the second zone(s) B, C, D. In another embodiment, the first actuator 1 is arranged in the first zone A. The first actuator 1 can also be arranged outside of the first zone A as described in the previous examples.

The unit comprises at least one second zone, i.e. the HVAC system comprises at least one second actuator 2. In FIG. 1, the unit (or sub-unit) comprises without any restriction to the invention three second zones B, C, D, i.e. the HVAC system comprises three second actuators 2. It is understood that the unit (or the sub-unit) can also comprise (only) one, two, four or more second zones with the HVAC system having one, two, four or more second actuators 2, respectively.

The second actuator 2 for second zone B is configured to change/control the physical variable in the second zone B. In one embodiment, the second actuator 2 for zone B is configured to receive a second control signal from the control apparatus 5 controlling its actuator position or its actuator mode. In one embodiment, the second actuator 2 for zone B is not able to control/influence the physical variable in the first zone A and/or one of other second zones C, D and/or of any other zone than the first zone A. In one embodiment, the second actuator 2 for zone B is arranged in the (supply or return) HVAC fluid conduct (including at its outlet), preferably in a branch of the HVAC fluid conduct which supplies only the second zone B and/or which does not supply the first zone A and/or (one of) the second zone C, D. In another embodiment, the second actuator 2 for zone B is arranged in the exhaust or return HVAC fluid conduct (including at its inlet), preferably in a branch of the exhaust HVAC fluid conduct which receives the exhaust HVAC fluid only from the second zone B and/or which does not receive the exhaust HVAC fluid from the first zone A and/or from the other second zones C, D. In another embodiment, the second actuator 2 is arranged in the second zone B.

The second actuator 2 for second zone C is configured to change/control the physical variable in the second zone C. In one embodiment, the second actuator 2 for zone C is configured to receive a second control signal from the control apparatus 5 controlling its actuator position or its actuator mode. In one embodiment, the second actuator 2 for zone C is not able to control the physical variable in the first zone A and/or one of other second zones B, D and/or of any other zone than the first zone A In one embodiment, the second actuator 2 for zone C is arranged in the HVAC fluid conduct (including at its outlet), preferably in a branch of the HVAC fluid conduct which supplies only the second zone C and/or which does not supply the first zone A and/or (one of) the second zone B, D. In another embodiment, the second actuator 2 for zone C is arranged in the exhaust HVAC fluid conduct (including at its inlet), preferably in a branch of the exhaust HVAC fluid conduct which receives the exhaust HVAC fluid only from the second zone C and/or which does not receive the exhaust HVAC fluid from the first zone A and/or from the other second zones B, D. In another embodiment, the second actuator 2 for zone C is arranged in the second zone C.

The second actuator 2 for second zone D is configured to change/control the physical variable in the second zone D. In one embodiment, the second actuator 2 for zone D is configured to receive a second control signal from the control apparatus 5 controlling its actuator position or its actuator mode. In one embodiment, the second actuator 2 for zone D is not able to control the physical variable in the first zone A and/or one of other second zones B, C and/or of any other zone than the first zone A In one embodiment, the second actuator 2 for zone D is arranged in the HVAC fluid conduct (including at its outlet), preferably in a branch of the HVAC fluid conduct which supplies only the second zone D and/or which does not supply the first zone A and/or (one of) the second zone B, C. In another embodiment, the second actuator 2 for zone D is arranged in the exhaust HVAC fluid conduct (including at its inlet), preferably in a branch of the exhaust HVAC fluid conduct which receives the exhaust HVAC fluid only from the second zone D and/or which does not receive the exhaust HVAC fluid from the first zone A and/or from the other second zones B, C. In another embodiment, the second actuator 2 for zone D is arranged in the second zone D.

The sensor 3 is configured to measure a value of the physical variable in the first zone A. In one embodiment, the sensor 3 measures periodically/continuously the value of the physical variable in order to periodically/continuously have the actual value of the physical variable in the first zone A. In one embodiment, the sensor 3 is connected to the control apparatus 5 and/or sends (periodically/continuously) the value measured to the control apparatus 5. The sensor 3 is preferably arranged in the first zone A. However, it is also possible that the sensor 3 is arranged outside of the first zone A, e.g. in the exhaust HVAC fluid conduct (including at its inlet), preferably in a branch of the exhaust HVAC fluid conduct which receives the exhaust HVAC fluid only from the first zone A and/or which does not receive the exhaust HVAC fluid from the second zone(s) B, C, D. Preferably, the sensor 3 is configured or arranged such that a value of the physical variable in the second zone(s) B, C, D does not influence the measurement of the sensor 3. The sensor 3 can be incorporated in the first actuator 1 so that the first actuator 1 and the sensor 3 for the first zone A can be installed with only one common device. Alternatively, the sensor 3 and the first actuator 1 are distinct devices. The sensor 3 can be realized in different devices, for example for measuring a more dimensional physical parameter wherein each sensor device measures a different dimension of the physical parameter, i.e. a different one of a first physical parameter and a second physical parameter.

The user input apparatus 4 is configured for receiving user input for each of the at least one second zone B, C, D. This includes also the embodiment, where the user input of one of the second zones for example B is used to determine automatically the user input for another second zone for example C and/or D based on the user input of the one second zone B (without necessarily requiring a user inputting the user input for the other second zone). In one embodiment, the user input received comprises a relative information about the physical parameter. For the temperature, the user input for (one/each of) the second zone(s) B, C, D could be to heat more or less or to cool more or less. For the temperature, the user input for (one/each of) the second zones B, C, D could be that the second zone is too cold or too warm. In one embodiment, the user input for (one/each of) the second zone(s) B, C, D received comprises an absolute information of the physical parameter in this second zone B, C, D. The relative information could be an absolute difference value of the physical parameter with respect to the target value of the first zone A, e.g. +x° C. or −x° C. or a relative difference value of the physical parameter with respect to the target value of the first zone A, e.g. +x% or −x% or just any other qualitative information as a knob position on a slider or knob. The user input for this second zone B, C, D could be the absolute target value for this second zone B, C, D. A relative information for the second zone B, C, D could then be computed on the basis of a difference between the absolute target temperature of the first zone A and the absolute target temperature of the second zone B, C, D. Preferably, the user input apparatus 4 is configured for receiving user input for the first zone A. The user input for the first zone A is preferably a target value for the physical parameter. The target value can also be a target range. Preferably, the user input apparatus 4 is configured for receiving user input for all zones A, B, C, D.

In one embodiment, the user input apparatus comprises a mobile user input device, preferably a smartphone and/or a tablet with an app for the user input of the HVAC system. However, the mobile user input device can also be a classic remote control. In one embodiment, the user input apparatus comprises a fixed user input device (non-removably) installed in the unit, e.g. in the first zone A or in the second zone B. In one embodiment, the user input apparatus comprises a plurality of user input devices (non-removably) installed in a plurality of zones, e.g. in the first zone A and in the second zones B, C, D. In one embodiment, the user input apparatus 4 could comprise a virtual user input apparatus such as web-page so that any web-browser capable device can be used as user input apparatus 4. The user input apparatus 4 can comprise any combination of the above-mentioned user inputs apparatuses 4.

The user input apparatus and/or the user input device(s) as described above is/are connected with the control apparatus 5 to send the user input received from a user to the control apparatus 5. The connection between the user input apparatus 4 and the control apparatus 5 can be realized by a wired and/or wireless connection. The connection between the user input apparatus 4 and the control apparatus 5 can be realized by a fieldbus, optically (e.g. infrared), by LAN, by WLAN, by radio, by internet, by mobile phone network (GSM, GPRS, UMTS, LTE, etc.), by low power wireless technology (LoRa, Bluetooth low energy BLE), Near field communication (NFC)) or by any combination of those.

In one embodiment, the user input apparatus 4 is configured to associate automatically a user input received to one of the zones A, B, C, D. This association can be performed based on the altitude and/or location of the user input device in the unit. For a mobile user input device, the location can be measured based on a triangulation sensor in the mobile user input device or based on image recognition. The triangulation sensor can be a satellite position sensor, a WLAN triangulation sensor or a general TOF sensor. The altitude can be measured based on a pressure altimeter in the user input device. The association of the user input to one of the zones A, B, C, D can also be based on a presence detection of the user, when he inputs the user input.

In one embodiment, the user input apparatus is configured to receive tactile user input. In one embodiment, the user input apparatus is a touch screen. In one embodiment, the user input apparatus is configured to receive audio or speech user input. In one embodiment, the user input apparatus is configured to receive gesture user input. The user input apparatus can comprise any combination of the above-mentioned user input ways.

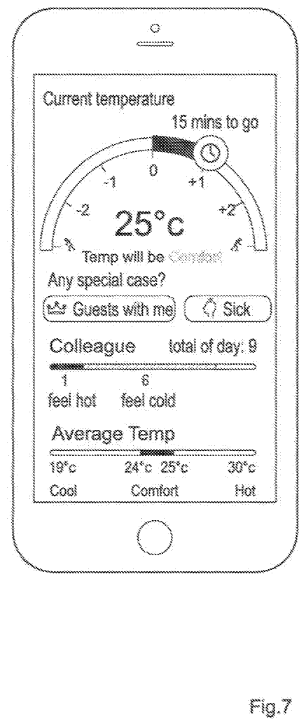

In one embodiment, the user input apparatus 4 receives the user input for the second zone B from a plurality of users. The user input for the second zone B (used for the later described control of the second actuator 2) is then determined based on the user input of the plurality of users. The user input for the second zone B is preferably based on the average of the user input of the plurality of users. In one embodiment, the average of the user input of the plurality of users is a weighted average of the user input of the plurality of user. This allows to give the user input of different users different weights. The weights can be determined by a user input of the users as shown for example in FIG. 7 where the user can say that he has a guest and weigh is input more than the user input of other users. The weight can also be determined by an administrator which fixes a weight to certain persons. The weight can also be determined automatically by the system based on parameters of the user, e.g. the location and/or altitude of the user, the time a user has spent (actually or in the average) in the second zone B, or many more. The position of the user within the second zone B can be used to weigh the user input of this user. For example the user input in the centre of the second zone B can be weight more than another user at the border of the second zone B with another second zone C. Also the time, a user has spent in the second zone B can be used to weigh the user input of the user differently. This allows to weigh the user input of a user who spends just a short time in the second zone B less than of a user who does not move from the second zone B for a long time. Preferably, the plurality of users has (each or at least some) a mobile user input device associated to the user such that the parameter of the user can be determined automatically from the mobile user input device of the user. Thus, it can be determined from mobile user input device of a user, the position and/or the time of the user in the second zone B. In one embodiment, when a user changes from one second zone B to another second zone C or D, his user input will automatically reassociated to the user input of the new second zone C or D based on the plurality of users in the new second zone C or D. Thus, the user input of the user changing the zone will not be considered anymore in the user input for the previous second zone B based on the user input of the plurality of users being in the second zone B, and the user input of the user changing the zone will be newly considered in the user input for the new second zone C or D based on the user input of the plurality of users being in the new second zone C or D.

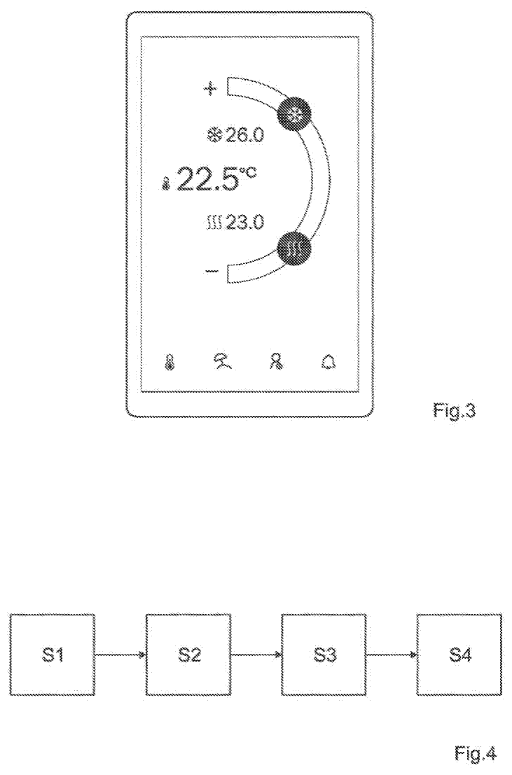

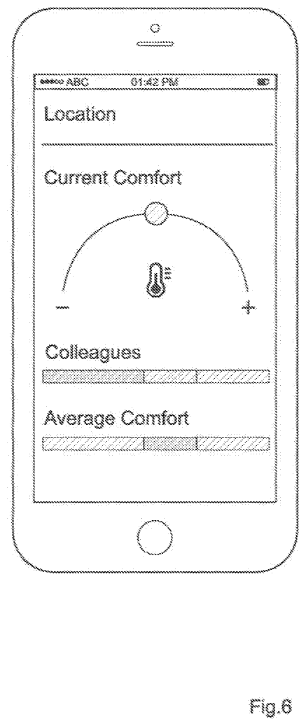

FIG. 2 shows an exemplary user interface displayed on a mobile user input device or on another user input apparatus 4. Preferably, the user interface shown is well adapted for a touch screen, but can also be used with a classic display in combination with other tactile user input devices like mouse, buttons, keys, etc. The user interface shown in FIG. 2 allows providing a user input for the/all zones A, B, C and D of the unit. Preferably, the user interface provides for (one/each of) the second zone(s) a slide bar for inputting a change of the physical variable in the second zone relative to the physical variable in the first zone. This could be realized with a slide bar. The relative information relating to each second zone B, C, D could be also input by a separate user interface display as shown for example in FIG. 5. This separate user interface display can be reached for example by clicking on the user interface display of FIG. 2 on the respective second zone B, C, D. Preferably, the user input relating to the second zone B, C, D is realized by a (virtual) state indicator whose position can be moved in two directions out of a neutral position. This movement could be a rotation and/or a translation. Preferably, the state indicator can be moved between two extreme positions. In one embodiment, the state indicator being in one of the two extreme positions could give an additional information. This could be for example that the second actuator 2 is controlled such that the HVAC function is continuously switched on or off. In one embodiment, the relative information relating to a second zone B, C, D could comprise a combination of relative information for this second zone from different users. This is shown for example in FIGS. 6 and 7, wherein the user is here called exemplarily Colleague. The user input interface for inputting a user input of one user with respect to the second zone B, C, D could comprise special cases, in which the user input of this user for this second zone B is weighted different (more or less) than the user input from the other users in the second zone B. This is shown in FIG. 7 as “Any special case?” which allows to select the special cases “Guests with me” or “sick”. The user input interface could further show some additional information when inputting the user input for the second zone B, C, D. This additional information could be the location or the name of the second zone B, C, D for which the user input is received as shown in FIG. 6 by “Location”. The additional information could comprise an information about the user input for the second zone B, C, D of the other users or colleagues as shown in FIGS. 6 and 7. The information about the user input for the second zone B, C, D of the other users could show the number of users which feel cold (or wants the second zone B, C, D to be warmer), the number of users which feel hot (or wants the second zone B, C, D to be cooler), the total number of users in the second zone B and/or the number of users which feel fine (or do not want to change the temperatures of the second zone B, C, D, the number of users which feel hot (or wants the second zone B, C, D to be cooler). In FIG. 7, from 9 users, 1 feel hot and 6 feel cold. The user input interface for the user input of a user could not be specific to a special second zone B, C, D as shown in FIG. 7 and could be allocated to the second zone B, C, D in which the user currently is located. The additional information could further include the time until the comfort temperature of the user or until the (weighted) average comfort temperature of the users is achieved as shown in FIG. 7. The additional information could further show the (weighted) average comfort temperate of the users in the second zone B, C, D. FIG. 3 shows a user input interface for inputting a user input with respect to the first zone A. A slide bar (here in a curved form) allows to set one or more target value(s). If the HVAC system can be operated in more modes, e.g. heating and cooling, there could be at least two target values, one for the first mode (e.g. for heating 23° C.) and another one for the second mode (e.g. for cooling 26° C.)

The control apparatus 5 is any processing means configured to perform the subsequently described control functions. The processing means performing the control functions can be arranged in a separate control device or can be incorporated in one or more of the first actuator 1, the second actuator 2, the sensor 3 and the user input device 4. The processing means performing the control functions could also be distributed over at least two devices. Those at least two devices can be two or more of a first control device, a second control device, the first actuator 1, the second actuator 2, the sensor 3 and the user input device 4. The control device could also be arranged remote from the first and second zone A, B, C and D, for example in a remote server. Preferably, the control apparatus 5 is configured to control the first actuator 1 on the basis of the value measured by the sensor 3. The term “control an actuator on the basis of y” means that the actuator is controlled and/or adjusted based on y. Preferably, the control apparatus 5 is configured to control the first actuator 1 on the basis of the value measured by the sensor 3 and on the basis of the user input received for the zone A. The user input for the zone A is preferably a target value for the physical variable. The control apparatus 5 is configured to generate a first control signal for the first actuator 1 depending on the value measured by the sensor 3 and eventually on the user input received for the zone A. In the example shown in FIG. 3, the control apparatus 5 controls the first actuator 1 such that it heats the zone A until the temperature measured in the first zone A reaches the lower target value of for example 23° C. of the first zone A and/or such that it cools the zone A until the temperature measured in the first zone A reaches the upper target value of for example 26° C. of the first zone A. The control depends generally on the mode of the HVAC system. If the HVAC system is in a cooling mode, the cooling control operates and if the HVAC system is in a heating mode, the heating control with the heating target value operates. This corresponds to a classic feedback control for HVAC systems.

According to the invention, the control apparatus 5 is configured to control the second actuator 2 of the second zone B on the basis of the configuration of the first zone A and on the basis of the user input for the second zone B. Preferably, the control apparatus 5 is configured to control the second actuator 2 of the second zone B without considering a measurement of the physical variable within the second zone B. The control apparatus 5 is configured to generate a second control signal for the second actuator 2 depending on the configuration of the first zone A and on the user input received for the second zone B. The second control signal is sent to the second actuator 2 of the second zone B to control the second actuator 2 based on the second control signal. The configuration of the first zone A can be the measurement of the sensor 3 for the first zone A and/or a control parameter of the first actuator 1 influencing the physical parameter measured at the sensor 3. Preferably, the configuration of the first zone A is or comprises the control parameter of the first actuator 1. Thus, the control apparatus 5 is configured to control the second actuator 2 of the second zone B and/or to generate the second control signal on the basis of the control parameter of the first actuator 1 and on the basis of the user input for the second zone B. Preferably, the control apparatus 5 is configured to set a control parameter of the second actuator 2 of the second zone B on the basis of said control parameter of the first actuator 1 adapted (increased or decreased or maintained equal) on the basis of the user input for the second zone B. The direction of adaption can depend further on the operation mode of the HVAC system (heating or cooling). The (setting of the second actuator 2 based on the) control parameter of the second actuator 2 is preferably sent with the second control signal to the second actuator 2. Preferably, the control parameter of the first actuator 1 can be the opening state of the first actuator 1 or the fluid flow through the first actuator 1 (in particular if the first actuator 1 controls the physical parameter by changing the fluid flow to or from the first zone A). However other control parameters of the first actuator 1 are possible. The control parameter of the second actuator 2 is preferably of the same type as the control parameter of the first actuator 1, e.g. both an opening state of the respective actuator 1/2 or both a fluid flow through the respective actuator 1/2. A fluid flow can be any parameter indicating a fluid flow like pressure, fluid flow velocity and others. If the control parameter of the second actuator 2 is a setting parameter (e.g. an electrical or mechanical setting parameter) of the second actuator 2 (e.g. opening state or fan velocity or pump mode), the control parameter of the second actuator 2 generated by the control apparatus 5 can be directly set on the second actuator 2. If the control parameter of the second actuator 2 is a parameter influenced by (the setting of) the second actuator 2 (e.g. fluid flow), the control parameter of the second actuator 2 generated from the control apparatus 5 can be used to control the setting of the second actuator 2 such that the actual control parameter of the second actuator 2 corresponds to the control parameter of the second actuator 2 generated by the control apparatus 5 based on the control parameter of the first actuator 1 and based on the user input for the second zone B. In the example in FIG. 2, the physical parameter is the temperature and the HVAC system heats. The target value of the temperature for zone A is 23° C. and the actual value of the temperature measured for zone A is 22.5° C. The user input for the second zone B indicates a relative information that the second zone B should be cooler or less heated (e.g. −10% or −2,3 ° C.). The control apparatus 5 controls the control parameter of the second actuator equal to a function of the relative information and the control parameter of the first actuator 1. Consequently, the second actuator 2 has a setting which heats less than the setting of the first actuator 1 such that a lower temperature is achieved in the second zone B, e.g. 20° C. The user can thus adapt the user input for the second zone B to achieve his desired temperature in there without the need of a separate temperature sensor in the second zone B.

The control apparatus 5 is further configured to control the further second zones C and/or D as described for the second zone B.

The control apparatus 5 can have two different control modes, when the target value of the physical parameter for the first zone A is changed (and the user input for the second zone B is not changed by the user at the same time).

In a first control mode, the relative information retrieved from the user input for the second zone B does not change so that final temperature in each of the first and second zone A and B will change. Since the new target value of the physical parameter will influence the control parameter of the first actuator 1, the control parameter of the second actuator 2 based on the new control parameter of the first actuator 1 and the (unchanged) relative information retrieved from the user input for the second zone B will change. When the target temperature in the first zone A is increased from 23° C. to 25° C., the control parameter of the first actuator 1 will change based on the new target temperature. Consequently, also the second control parameter will be adapted based on the new control parameter of the first actuator 1. As a consequence and since all relative information from the user input for the second zones B, C, D all remain unchanged by the change of the target temperature, all second zones B, C, D will become relatively warmer due to the new control parameter of the first actuator 1.

In a second control mode, the relative information retrieved from the user input for the second zone B is adapted based on the change of the target temperature such that the absolute value of the physical parameter remains (substantially) unchanged in the second zones B, C, D. Since the new target value of the physical parameter will influence the control parameter of the first actuator 1, but the change of the control parameter of the first actuator 1 is at least partly compensated by the change of the relative information of the user input for the second zones B, C, D, the control parameter of the second actuator 2 will remain (substantially) stable. If the target temperature in the first zone A is increased from 23° C. to 25° C., the control parameter of the first actuator 1 will change based on the changed target temperature, and the (relative information retrieved from the) user input for the second zone B will change to compensate the changed target temperature. Consequently, also the second control parameter will be adapted based on the new control parameter of the first actuator 1 and of the new relative information such that the temperature in the second zones B, C, D remains (substantially) constant.

In one embodiment, the control parameter of the first and second actuator 1 and 2 is the fluid flow through the respective actuator 1/2. In one embodiment, the fluid flow is measured for each actuator 1 and 2 with a respective fluid flow sensor associated with the respective actuator 1 and 2. In another embodiment, only one of the first and second actuator 1 and 2, preferably the first actuator 1, has a fluid flow sensor associated and the fluid flow of the other actuator, preferably the second actuator 2, is retrieved based on the measurement of the fluid flow at the one actuator corrected by a setting information associated with the other actuator and/or the opening state of the other actuator corrected by a setting information associated with the other actuator. The setting information considers the difference in fluid flow pressure due to the position of the actuator in the fluid conduit system. The setting information can be measured or input by a user or a commissioner once, e.g. at commissioning. WO2013/000785 is incorporated by reference for more details about the retrieval and/or setting of the fluid flow in the actuators 1 and/or 2.

In one embodiment, the control apparatus 5 is a control device installed in the unit. In another embodiment, the control apparatus 5 is a control device arranged outside of the unit. In one embodiment, the control apparatus 5 is a remote control apparatus, e.g. installed on a remote server.

The control apparatus 5 is connected with the actuators 1, 2 and/or the sensor 3. The connection can be realized by a wired connection and/or by a wireless connection. The connection can be realized by a fieldbus, optically (e.g. infrared), by LAN, by WLAN, by radio, by internet, by mobile phone network (GSM, GPRS, UMTS, LTE, etc.), by low power wireless technology (LoRa, Bluetooth low energy BLE), Near field communication (NFC)) or by any combination of those. Obviously, if the control apparatus 5 is arranged in one of the actuator 1, 2 and/or the sensor 3, the connection within the same device can be any PCB or wired connection.

In one embodiment, the unit has two or more sub-units. In this case. The HVAC system comprises for each sub-unit a first actuator 1, at least a second actuator 2 associated to the first actuator 1 of the same sub-unit, a sensor 3 for measuring the value of the physical parameter of the first zone of the same sub-unit. The HVAC system for each sub-unit works as described before for the unit. Each first zone A has a sensor 3.

In one embodiment, the control apparatus could have for each sub-unit a separate sub-control apparatus with the above-described function of the control apparatus 5 for the respective sub-unit. In an alternative embodiment, the at least two sub-units could use the same control apparatus 5 for the control of more or all sub-units. Also a combination is possible with a common control device for all sub-units which controls sub-control devices in each sub-unit controlling the HVAC system of the respective sub-unit. The control apparatus 5 and/or the sub-control apparatus is such that the second actuator 2 of each of the at least one second zone B, C, D of each sub-unit is controlled on the basis of the configuration for the first zone A and/or of the control parameter of the first actuator 1 of the same sub-unit and on the basis of the user input for the second zone B of the same sub-unit.

In one embodiment, the user input apparatus could comprise for each sub-unit a separate sub-unit user input apparatus 4 with the above-described function for the respective sub-unit. In an alternative embodiment, the at least two sub-units could use the same user input device/apparatus 4 for providing the user input for the second zones of different sub-units, i.e. for second zones associated to different first zones A.

In one embodiment, the user input apparatus 4 is configured to associate or allocated automatically a user input received to one of the sub-units. This association can be performed based on the altitude and/or location of the user input device in the unit. For a mobile user input device, the location can be measured based on a triangulation sensor in the mobile user input device or based on image recognition. The triangulation sensor can be a satellite position sensor, a WLAN triangulation sensor or a general time of flight (TOF) sensor. The altitude can be measured based on a pressure altimeter in the user input device. The latter could be used, if different sub-units are arranged in different floors. The association of the user input to a sub-unit can also be performed based on a presence detection of the user when he inputs the user input.

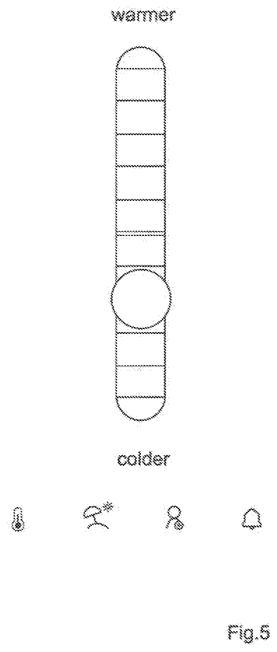

FIG. 4 shows an embodiment of an HVAC method. In step S1, a value of a physical variable is measured in the first zone A with the sensor 3. In step S2, the physical variable in the first zone A is controlled on the basis of the value measured in the first zone A. In step S3, a user input is received for the second zone B, C, D. In step S4, the physical variable in the second zone B, C, D is controlled on the basis of the configuration in the first zone A and/or of the control parameter of the first actuator 1 and on the basis of the user input for the second zone B, C, D. The order of the steps S1 to S3 is arbitrary. They can be performed in parallel and/or at any order. After the steps S1 to S3, the step S4 follows.

1. A HVAC system for a unit with a first zone (A) and a second zone (B, C, D) comprising:
a first actuator (1) configured to change a physical variable in the first zone (A);
a second actuator (2) configured to change the physical variable in the second zone (B, C, D);
a sensor (3) configured to measure a value of the physical variable in the first zone (A);
a user input apparatus (4) for receiving user input for the second zone (B, C, D);
a control apparatus (5) configured to control the first actuator (1) on the basis of the value measured by the sensor (3) and configured to control the second actuator (2) on the basis of the configuration of the first zone (A) and on the basis of the user input for the second zone (B, C, D).

2. The HVAC system according to claim 1, wherein the control apparatus (5) is configured to control the second actuator (2) without considering a measurement of a value of the physical variable in the second zone.

3. The HVAC system according to claim 1, wherein the physical variable comprises the temperature.

4. The HVAC system according to claim 1, wherein the control apparatus (5) is configured to control the second actuator (2) on the basis of a control parameter of the first actuator (1) adapted based on the user input for the second zone (B, C, D).

5. The HVAC system according to claim 1, wherein the physical variable comprises the concentration of carbondioxid, carbonmonoxid, aerosols, volatile organic compounds or hydrogen ions, particles or humidity in the air.

6. The HVAC system according to claim 1, wherein the second actuator (2) is not able to influence the value of the physical variable in the first zone (A).

7. The HVAC system according to claim 1, wherein the user input apparatus (4) is further configured to receive a user input for the first zone (A), wherein the control apparatus (5) is configured to control the first actuator (1) on the basis of the value measured by the sensor (3) and on the basis of the user input for the first zone (A).

8. The HVAC system according to claim 1, wherein the unit comprises at least one further second zone (B, C, D), wherein each at least one further second zone (B, C, D) comprises a further second actuator (2), wherein the user input apparatus is configured for receiving user input for each of the at least one further second zone (B, C, D), wherein the control apparatus (5) is configured to control each of the further second actuator (2) on the basis of the configuration of the first zone (A) and on the basis of the user input for the respective further second zone (B, C, D).

9. The HVAC system according to claim 1, wherein the unit comprises at least two sub-units, wherein each sub-unit comprises a first zone (A), a second zone (B, C, D), a first actuator (1) configured to change a physical variable in the first zone (A) of the respective sub-unit, a second actuator (2) for each second zone of the respective sub-unit configured to change the physical variable in the second zone (B, C, D) of the respective sub-unit and a sensor (3) configured to measure a value of the physical variable in the first zone (A) of the respective sub-unit, wherein the user input apparatus (4) is configured for receiving user input for the second zones (B, C, D) of each sub-unit, wherein the control apparatus (5) is configured to control the first actuator (1) of the respective sub-unit on the basis of the value measured by the sensor (3) of the respective sub-unit and configured to control the second actuator (2) of the respective sub-unit on the basis of the configuration of the first zone (A) of the respective sub-unit and on the basis of the user input for the respective second zone (B, C, D) of the same respective sub-unit.

10. The HVAC system according to claim 1, wherein the user input apparatus (4) and/or the control apparatus (5) is configured to associate a user input received at the user input apparatus (4) to a second zone (B, C, D) and/or to a first zone (A) based on the position of the user input apparatus (4) and/or based on the altitude of the user input apparatus (4) measured by a pressure altimeter and/or based on an indoor location system.

11. The HVAC system according to claim 1, wherein the user input for the second zone (B, C, D) is a relative information of the physical parameter of the second zone (B, C, D) with respect to the physical parameter of the first zone (A).

12. The HVAC system according to claim 1, wherein the first zone (A) and the second zone (B, C, D) are in different rooms of the unit.

13. The HVAC system according to claim 1, wherein the user input apparatus (4) receives a different sub user inputs for the second zone (B, C, D) from different users and determines user input for the second zone (B, C, D) based on the different sub user inputs for the second zone (B, C, D) from the different users.

14. A method for a HVAC system having a unit with a first zone (A) and a second zone (B, C, D) comprising:
measuring a value of a physical variable in the first zone (A);
controlling the physical variable in the first zone (A) on the basis of the value measured in the first zone (A);
receiving user input for the second zone (B, C, D);
controlling the physical variable in the second zone (B, C, D) on the basis of the configuration in the first zone (A) and on the basis of the user input for the second zone (B, C, D).

15. A non-transient recording medium containing a program for controlling an HVAC system for a unit with a first zone (A) and a second zone (B, C, D) comprising a instructions configured to perform the following steps, when executed on a processor;
receiving, in the processor, a value of the physical variable in the first zone (A) from a sensor (3) of the HVAC system;
outputting, in the processor, a first control signal to a first actuator (1) of the HVAC system for controlling a physical variable in the first zone (A) on the basis of the value received from the sensor (3);
receiving, in the processor, user input for the second zone (B, C, D) from a user input apparatus (4) of the HVAC system;
outputting, in the processor, a second control signal to a second actuator (2) of the HVAC system for controlling the physical variable in the second zone (B, C, D) on the basis of the configuration of the first zone (A) and on the basis of the user input for the second zone (B, C, D).
